(19) United States
(12) Patent Application Publication
(10) Pub. No.: US 2005/0008925 A1
(43) Pub. Date: Jan. 13, 2005

(54) Fuel cell

(76) Inventor: Liqing Hu, Shanghai (CN)

Correspondence Address: Raymond Y. Chan;Suite 128, 108 N. Ynez Ave., Monterey Park, CA, 91754, US

(21) Appl. No.: 10/888,760

(22) Filed: Jul. 9, 2004

(30) Foreign Application Priority Data
Jul. 9, 2003 (CN) 03141479.6

(51) Int. Cl. H01M 8/04; H01M 8/02; H01M 4/86

(52) U.S. Cl. 429/38; 429/32; 429/26; 429/40

(57) ABSTRACT

The present invention disclosed a fuel cell comprises a plurality of cell bodies electrically connected in a series manner, each of the cell bodies having an anode catalytic interface and an opposed a cathode catalytic interface, a proton exchange membrane, sandwiched between each the two adjacent cell bodies to communicate with the anode catalytic interface and the cathode catalytic interface thereof to form a fuel cell stack, and a reacting passage arrangement for generating an electrochemical reaction between the anode catalytic interfaces and the cathode catalytic interfaces of the cell bodies, wherein the reacting passage arrangement has a flowing channel having an inlet and an outlet for allowing a reactant to pass through the fuel cell stack from the inlet to the outlet so as to electrochemically react with the proton exchange membrane, wherein the flowing channel is shaped and sized to balance an entrance pressure of the reactant at the inlet with an exit pressure of the reactant at the outlet so as to ensure the electrochemical reaction at each two the adjacent cell bodies at a stable manner.

### BACKGROUND OF THE PRESENT INVENTION

1. Field of Invention

The present invention relates to electrochemical fuel cells, more particularly, relates to a fuel cell, wherein the cell bodies alignedly positioned in the end portion are specifically restructured for improving the overall operative performance of the fuel cell.

2. Description of Related Arts

Electrochemical fuel cell is a kind of electrochemical energy conversion device which is capable of converting the hydrogen and oxidant into electrical energy. The core part of this kind of device is a membrane electrode assembly (MEA). The MEA comprises a proton exchange membrane sandwiched by two porous sheets made of conductive material such as carbon tissue. At the same time, a layer of catalyst like metal platinum powder, adapted for facilitating the electrochemical reaction, are evenly and granularly provided on two layers of carbon tissue to form two catalytic interfaces. Furthermore, electrically conductible members are provided on two sides of MEA to form a cathode and an anode, in such a manner, electron generated from the electrochemical reaction are capable of being lead out through an electrical circuit.

The anode of the MEA is supplied with fuel, such as hydrogen, for initiating the electrochemical reaction. The fuel is forced through the porous and diffused carbon tissue, and is capable of being deionized on the catalytic interface for the loss of electrons to generate positive ions. Moreover, positive ions are capable of transferably penetrating the proton exchange membrane to reach the cathode. On the other hand, an oxidant-containing gas, such as air, is supplied to the cathode of the MEA. Accordingly, the oxidant-containing gas is able to penetrate the porous and diffused carbon tissue to be ionized for the addition of the electrons to generate negative ions. Finally, the positive ions transferred from the anode will meet the negative ions to form reaction product.

In the electrochemical fuel cells which employ the hydrogen as the fuel and oxygen containing air as the oxidant, the electrochemical reaction on the anode generates hydrogen positive ions (protons). The proton exchange membrane is capable of facilitating the hydrogen positive ions migrate from the anode to the cathode. In addition, the proton exchange member has another function as a separator for blocking hydrogen containing air flow from being directly contacted with the oxygen containing air flow so as to prevent the mixture of hydrogen and oxygen as well as the explosive reaction.

The electrochemical reaction on the cathode side of fuel cell generates negative ions by obtaining the electrons. As a result, the negative ions generated on the cathode side will attract the positive ions transferred from the anode side to form water molecule as reaction product. In the electrochemical fuel cells which utilized the hydrogen as the fuel and oxygen containing air as oxidant, the electrochemical reaction is expressed by the following formula:
Anode: H₂→2H⁺+2e
Cathode: ½O₂+2H⁺+2e→H₂O

In the typical proton exchanging membrane fuel cell system, the MEA is disposed between two electrically conductible electrode plates wherein the contacting interface of each electrode plate at least defines one flowing channel. The flowing channel could be embodied by conventional mechanical method such as pressure casting, punching, and mechanical milling. The electrode plate could be embodied as metal electrode plate or graphite electrode plate. So the flowing channels defined on the electrode plate are capable of directing fuel and oxidant into anode side and cathode side respectively positioned on opposite side of the MEA. For a single fuel cell structure, only one MEA is provided and disposed between an anode plate and a cathode plate. Here, the anode plate and the cathode plate not only are embodied as current-collecting device, but also as a supporting device for securely holding the MEA. The flowing channels defined on the electrode plate are capable of delivering fuel and oxidant to the catalytic interfaces of the anode and cathode, and removing the water discharged from the electrochemical reaction of fuel cell.

To increase the overall power output of the proton exchanging membrane fuel cell, two or more fuel cells are electrically connected in series with a stacked manner or a successive manner to form a fuel cell stack. In such stacked series manner, each electrode plate comprises flowing channels defined on opposite side of plate respectively wherein one side of the electrode plate is applied as an anode plate contacting with the anode interface of a MEA, while another side of the electrode plate is applied as a cathode plate contacting with the cathode interface of an adjacent MEA. That is to say, one side of such electrode plate serve as an anode plate for one cell body and the other side of plate serve as a cathode plate for the adjacent cell. Within the art, this kind of structure is called bipolar plate. However, in the successive series manner, a plurality of single cell bodies are connected successively, wherein a front end unipolar plate and rear end unipolar plate as well as a fastening member are provided to form an overall fuel cell.

Conclusively, a typical fuel cell comprises a first passage which has a first inlet and a first outlet adapted for evenly dispersing fuel, such as hydrogen, methanol, alcohol, natural gas, and hydrogen rich gas reformed from gasoline into the anode flowing channel; a second passage which has a second inlet and a second outlet adapted for evenly dispersing oxidant, such as oxygen and air, into the cathode flowing channel; a third passage which has a third inlet and a third outlet adapted for delivering coolant like water into coolant passage provided in the fuel cell stack and for absorbing the heat generated from the electrochemical reaction inside the fuel cell stack for a radiation purpose; wherein the first outlet and second outlet are also adapted for leading out the water generated from the electrochemical reaction. Commonly, all above mentioned inlets and outlets are defined on an end cell body or two opposite cell bodies.

It has been practiced in the art to use such fuel cell systems as power unit for propelling vehicles including four-wheeled motor vehicles and motorcycles and operating other electrically operated machines such as portable generators.

Presently, proton exchange membrane fuel cell commonly comprises a plurality of cell bodies combined together in stacked or series manner. This is to say that the fuel cell comprises at least a plurality of cell bodies, an anode current collecting plate, a cathode current collecting plate, a front end, a rear end and a fastening element wherein the inlets and outlets of fuel passage, oxidant passage, and the coolant passage are concentrated on the front end, the rear end, or a middle cell body as shown in FIGS. 1 through 3.

As shown in FIG. 1, three passage inlets and three passage outlets of the first, second and third passages respectively for delivering fuel, oxidant, and coolant are concentrated on a first cell body positioned at one end of the fuel cell stack. As shown in FIG. 2, three passage inlets of the first, second and third passages respectively for fuel, oxidant, and coolant are concentrated on a first cell body positioned at one end of the fuel cell stack, while three passage outlets of the first, second and third passages respectively for delivering fuel, oxidant, and coolant are concentrated on a last cell body positioned at another end of the fuel cell stack. As shown in FIG. 3, three passage inlets and three passage outlets of the first, second and third passages respectively for delivering fuel, oxidant, and coolant are concentrated on a cell body positioned in the middle of the fuel cell stack.

No matter which structure is used for disposing three passages of fuel, oxidant and coolant in the fuel cell, a primary object is to ensure that hydrogen is capable of being delivered to the anode reactive field defined on the cell body and excessive hydrogen and water generated from the electrochemical reaction are capable of being discharged from the passage as shown in FIG. 4. Accordingly, oxidant containing air is capable of being delivered to the cathode reactive field defined on the cell body and excessive oxygen and water generated from the electrochemical reaction are capable of being discharged from the second passage as shown in FIG. 5. Furthermore, coolant water is capable of being delivered to the reactive field defined on the cell bodies of a fuel cell stack to absorb the heat generated from the reaction.

In present, the design of the fuel cell is considerably focused on reducing the loss of current velocity during the flowing process of the reactant including fuel, oxidant and coolant, and ensuring that each cell body as well as the flowing channel, reactive field, and electrodes defined on the cell bodies having identical accuracy so as to guarantee that different flows (fuel, oxidant, and coolant) are evenly dispersed into each individual cell body of the fuel cell stack.

It is seen that cell bodies (electrode plates) of desirable mechanical accuracy have been used within the art to make the cell bodies having substantial uniformity. However, the electrodes with a better standard uniformity could not guarantee that each individual cell body of the fuel cell stack shares a desirable uniformity. The unbalanced performance of the cell bodies could cause serious consequence. This is due to the fact that since all cell bodies of the fuel cell stack are serially and electrically connected in a stacked manner, an inconsistent single cell body would cause antipolarizing effect under a large current situation. That is to say, the output voltage would be a negative value which would lead to permanent and unrecoverable damage to the fuel cell stack. Besides the common reasons causing the inconsistent performance among the fuel cell stack such as inferior machining process of electrode plate, poor quality of electrode, and bad assembling procedure, while a more important reason is the Bernoulli effects.

As shown in FIG. 6 to FIG. 8, the vertical ordinate P represents the pressure, the horizontal ordinate S represents the distance the flowing channel from the inlet or outlet, ΔP represents the pressure difference, and the arrow indicates the flowing direction of the liquid flow. The inventor of the present invention discovered that under the perfect circumstance, i.e. mechanical processing accuracy, property of electrode and assemblying procedure are all in ideal condition, the uniformity of all cell bodies within the fuel cell stack is inclusively rested on the pressure difference between flowing-in stream and flowing-out stream as shown in FIG. 8.

Due to the fact of Bernoulli Effects, the pressure difference between the flowing-in stream and flowing-out stream of the fuel cell positioned close to end portion, where the inlets and outlets defined, of a fuel cell stack is unusually high. At the same time, the pressure difference between the flowing-in stream and flowing-out stream of the middle fuel cells within a fuel cell stack is relatively low. As a result, the fuel, oxidant and coolant stream flowing through the fuel cell stack would be relatively concentrated on cell bodies positioned at the middle of the fuel cell stack, whereas relatively less dispersed at the cell bodies disposed at the end portion of the fuel cell stack. To sum up, this discovery of the inventor of the present invention gave a reasonable explanation why the cell bodies at two end portion of the a fuel cell stack shown inferior property under a large current circumstance.

### SUMMARY OF THE PRESENT INVENTION

A main object of the present invention is to provide a fuel cell as well as producing method thereof for improving the fuel cell to overcome above mentioned drawbacks thereby facilitating the uniformity of the cell bodies with the fuel cell. As a result, the durability and operational stability of the fuel cell could be significantly increased.

Another object of the present invention is to provide a fuel cell as well as producing method thereof for diminishing the Bernoulli Effects during the fuel cell operation.

Accordingly, to achieve the above mention object, the present invention provides a fuel cell, comprising:
a plurality of cell bodies electrically connected in a series manner, each of the cell bodies having an anode catalytic interface and an opposed a cathode catalytic interface;
a proton exchange membrane, having a plurality of pores, sandwiched between each the two adjacent cell bodies to communicate with the anode catalytic interface and the cathode catalytic interface thereof to form a fuel cell stack; and
a reacting passage arrangement for generating an electrochemical reaction between the anode catalytic interfaces and the cathode catalytic interfaces of the cell bodies, wherein the reacting passage arrangement has a flowing channel having an inlet and an outlet for allowing a reactant to pass through the fuel cell stack from the inlet to the outlet so as to electrochemically react with the proton exchange membrane, wherein the flowing channel is shaped and sized to balance an entrance pressure of the reactant at the inlet with an exit pressure of the reactant at the outlet so as to ensure the electrochemical reaction at each two the adjacent cell bodies at a stable manner.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fuel cell stack illustrating that all fluid inlets and outlets are concentrated on a front end plate.

FIG. 2 is a perspective view of a fuel cell stack illustrating those fluid inlets and outlets are respectively defined on two opposite end plates.

FIG. 3 is a perspective view of a fuel cell stack illustrating that all fluid inlets and outlets are concentrated on a middle plate.

FIG. 4 is a schematic view of a fuel cell stack illustrating the flowing fluid direction inside the fuel cell stack wherein the hydrogen fluid inlets and outlets are concentrated on a front end plate.

FIG. 5 is a schematic view of a fuel cell stack illustrating the flowing fluid direction inside the fuel cell stack wherein the oxygen fluid inlets and outlets are concentrated on a front end plate.

FIG. 6 is a schematic view of Bernoulli Effects of flowing in air fluid of the fuel cell stack.

FIG. 7 is a schematic view of Bernoulli Effects of flowing out air fluid of the fuel cell stack.

FIG. 8 is a schematic view of Bernoulli Effects of flowing in and flowing out air fluid of the fuel cell stack.

FIG. 9 is a schematic view of Bernoulli Effects of flowing in and flowing out air fluid of the fuel cell stack.

### DETAILED DESCRIPTION OF THE PREFERRED EMBODIMENT

The present invention provides a fuel cell, which comprises a plurality of cell bodies electrically connected in a series manner, each of the cell bodies has an anode catalytic interface and an opposed a cathode catalytic interface.

The fuel cell further comprise a proton exchange membrane, having a plurality of pores, sandwiched between each the two adjacent cell bodies to communicate with the anode catalytic interface and the cathode catalytic interface thereof to form a fuel cell stack, and a reacting passage arrangement for generating an electrochemical reaction between the anode catalytic interfaces and the cathode catalytic interfaces of the cell bodies, wherein the reacting passage arrangement has a flowing channel having an inlet and an outlet for allowing a reactant to pass through the fuel cell stack from the inlet to the outlet so as to electrochemically react with the proton exchange membrane, wherein the flowing channel is shaped and sized to balance an entrance pressure of the reactant at the inlet with an exit pressure of the reactant at the outlet so as to ensure the electrochemical reaction at each two the adjacent cell bodies at a stable manner.

Furthermore, the flowing channel comprises a fuel passage provided at the anode catalytic interface of each of the cell bodies for supplying a fuel as the reactant to provide electrons, an oxidant passage provided at the cathode catalytic interface of each of the cell bodies for supplying an oxidant as the reactant, wherein the fuel and the oxidant are separately guided to pass through the fuel passage and the oxidant passage respectively such that the oxidant is adapted for attracting the electrons through the proton exchange membrane so as to generate the electrochemical reaction.

Furthermore, the flowing channel further comprises a coolant passage provided at the cathode catalytic interface of each of the cell bodies for supplying a coolant to pass through the fuel cell stack so as to prevent an overheat of the fuel cell stack during the electrochemical reaction.

Referring to FIG. 1, the inlets and outlets of the flowing passage are spacedly provided at one of the cell bodies as a first cell body positioned at one end of the fuel cell stack, such that the flowing channel is extended from the first cell body through the remaining cell bodies and back to first cell body.

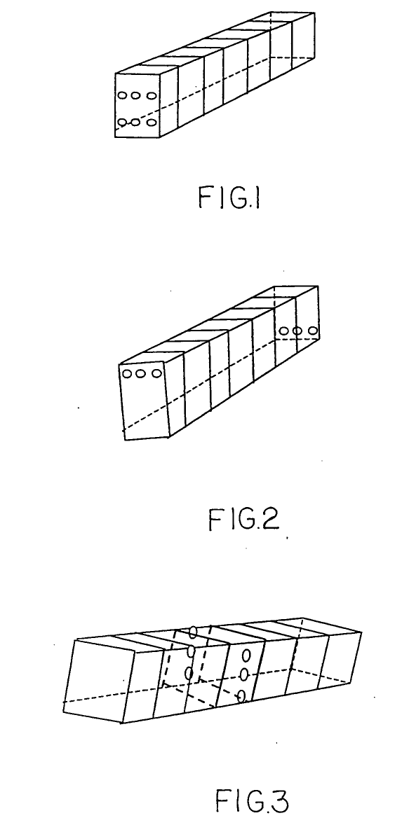

Referring to FIG. 2, the inlet of the flowing passage is provided at one of the cell bodies as a first cell body positioned at one end of the fuel cell stack and the outlet is provided at the cell body as a last cell body positioned at another end of the fuel cell stack, such that the flowing channel is extended from the first cell body through the last cell body through the cell bodies therebetween.

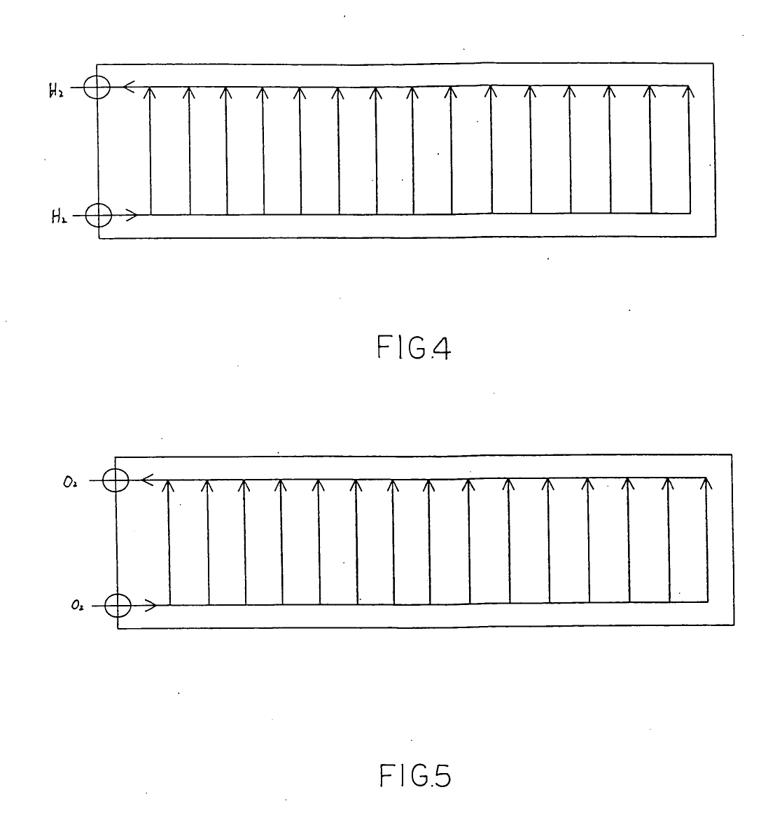

Referring to FIG. 3, the inlet and the outlet of the flowing channel are spacedly provided at one of the cell bodies positioned at a middle of the fuel cell stack, such that the flowing channel is extended from the respective cell body through two cell bodies at two ends of the fuel cell stack in a coil manner and back to the respective cell body.

No matter which structure is used for disposing three passages of fuel, oxidant and coolant in the fuel cell stack, a primary object is to ensure that hydrogen is capable of being delivered to the anode reactive field defined on the cell body and excessive hydrogen and water generated from the electrochemical reaction are capable of being discharged from the passage as shown in FIG. 4. Accordingly, oxidant containing air is capable of being delivered to the cathode reactive field defined on the cell body and excessive oxygen and water generated from the electrochemical reaction are capable of being discharged from the second passage as shown in FIG. 5.

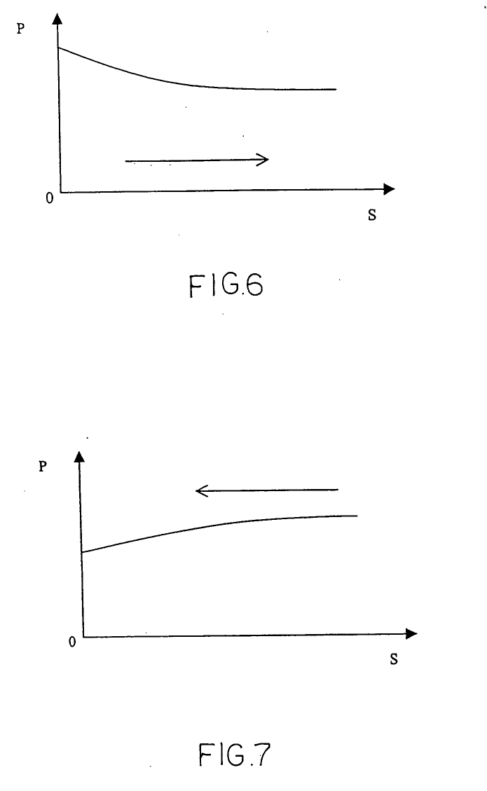

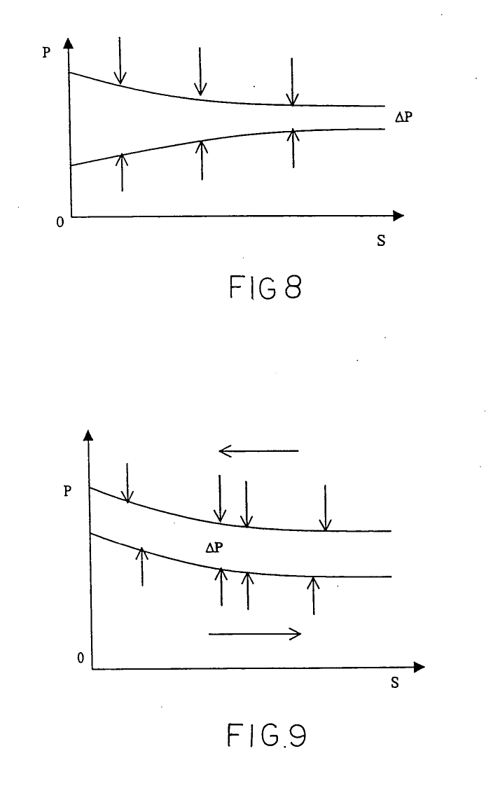

As mentioned before, the Bernoulli Effect is a main reason which causes an inferior performance of a fuel cell stack. Referring to the FIG. 6 and FIG. 7, the schematic view of Bernoulli Effects of flowing in air fluid and flowing out air fluid of the fuel cell stack are illustrated. The entrance pressure of flowing liquid is downwardly curved and the exit pressure of flowing out liquid is upwardly curved. That is to say, the pressure of the flowing liquid is gradually decreased which enables the pressure difference between the flowing in liquid and flowing out liquid at the cell bodies positioned at the inlets and outlets being higher as shown in FIG. 8 wherein the pressure difference ΔP is gradually narrowed along the horizontal coordinate.

Referring to the FIG. 9, the a schematic view of Bernoulli Effects of flowing in and flowing out air fluid of the fuel cell stack according to the first preferred embodiment, the second preferred embodiment and the third preferred embodiment of the present invention is illustrated.

The first embodiment provides a 10 KW fuel cell stack, operationally pressurized hydrogen and air each of which is provided with a 0.5 unit atmospheric pressure (relative pressure), a operational temperature within a range from 65° C. to 70° C., 70 fuel cells, the inlets and outlets of the flowing passage respectively for supplying hydrogen, air, and coolant are concentrated on the front end cell body as shown in FIG. 1. According to the present invention, the machining accuracy of flowing channels of each cell body is in perfect uniformity with a tolerance limitation of 1 decimillimeter, and the properties of all fuel cells bodies are identically formed.

As shown in FIG. 8, during the operation, the first and second cell body positioned close to the end of the fuel cell stack, wherein the inlets and outlets of the flowing channel are concentrated, indicate relative weaker performance to a 20% extent. According to the first preferred embodiment of the present invention, the flowing channel at the inlet and outlet of the fuel cell stack, i.e. the first and the second cell bodies positioned to the front end of the fuel cell stack are deepened 10 decimmilimeter in comparison with the remaining cell bodies in the fuel cell stack to improve the overall uniformity of fuel cell stack.

It is worth to mention that the depth of the flowing channel at the inlet and outlet is at least 0.1-20 decimmilimeter larger than that of the flowing channel between the inlet and outlet to balance the entrance pressure of the reactant at the inlet with the exit pressure of the reactant at the outlet of the flowing channel therefore offsetting the Bernoulli Effects. Here, the reactant includes fuel, oxidants and coolant. It is noted that Bernoulli Effects of conventional fuel cell stack have been diminished as shown in FIG. 9. In the FIG. 9, the vertical ordinate P represents the pressure, the horizontal ordinate S represents the distance the flowing channel from the inlet or outlet, ΔP represents the pressure difference, and the arrow indicates the flowing direction of the reactant. It is viewed from the FIG. 9 that the pressure difference ΔP is kept consistently throughout the operation.

The second embodiment provides a 10 KW fuel cell stack, operationally pressurized hydrogen and air each of which is provided with a 0.5 unit atmospheric pressure (relative pressure), a operational temperature within a range from 65° C. to 70° C., 70 fuel cells, the inlets and outlets of the flowing passage respectively for supplying hydrogen, air, and coolant are concentrated on the front end cell body as shown in FIG. 1. According to the present invention, the machining accuracy of flowing channels of each cell body is in perfect uniformity with a tolerance limitation of 1 decimillimeter, and the properties of all fuel cells bodies are identically formed.

As shown in FIG. 8, during the operation, the first and second cell body positioned close to the end of the fuel cell stack, wherein the inlets and outlets of the flowing channel are concentrated, indicate relative weaker performance to a 20% extent. According to the second preferred embodiment of the present invention, the flowing channel at the inlet and outlet of the fuel cell stack, i.e. the first and the second cell bodies positioned to the front end of the fuel cell stack are widened 10 decimmilimeter in comparison with the remaining cell bodies in the fuel cell stack to improve the overall uniformity of fuel cell stack.

It is worth to mention that the width of the flowing channel at the inlet and outlet is at least 0.1-20 decimmilimeter larger than that of the flowing channel between the inlet and outlet to balance the entrance pressure of the reactant at the inlet with the exit pressure of the reactant at the outlet of the flowing channel therefore offsetting the Bernoulli Effects. Here, the reactant includes fuel, oxidants and coolant. It is noted that Bernoulli Effects of conventional fuel cell stack have been diminished as shown in FIG. 9. In the FIG. 9, the vertical ordinate P represents the pressure, the horizontal ordinate S represents the distance the flowing channel from the inlet or outlet, ΔP represents the pressure difference, and the arrow indicates the flowing direction of the reactant. It is viewed from the FIG. 9 that the pressure difference ΔP is kept consistently throughout the operation.

The third embodiment provides a 10 KW fuel cell stack, operationally pressurized hydrogen and air each of which is provided with a 0.5 unit atmospheric pressure (relative pressure), a operational temperature within a range from 65° C. to 70° C., 70 fuel cells, the inlets and outlets of the flowing passage respectively for supplying hydrogen, air, and coolant are concentrated on the front end cell body as shown in FIG. 1. According to the present invention, the machining accuracy of flowing channels of each cell body is in perfect uniformity with a tolerance limitation of 1 decimillimeter, and the properties of all fuel cells bodies are identically formed.

As shown in FIG. 8, during the operation, the first and second cell body positioned close to the end of the fuel cell stack, wherein the inlets and outlets of the flowing channel are concentrated, indicate relative weaker performance to a 20% extent. According to the third preferred embodiment of the present invention, the reacting catalyst provided the anode catalytic interface and the cathode catalytic interface of the cell bodies at the inlet and outlet of the fuel cell stack for facilitating the electrochemical reaction has an amount larger than an amount of the reacting catalyst of the remaining cell bodies in the fuel cell stack to improve the overall uniformity of fuel cell stack.

It is noted that Bernoulli Effects of conventional fuel cell stack have been diminished as shown in FIG. 9. In the FIG. 9, the vertical ordinate P represents the pressure, the horizontal ordinate S represents the distance the flowing channel from the inlet or outlet, ΔP represents the pressure difference, and the arrow indicates the flowing direction of the reactant. It is viewed from the FIG. 9 that the pressure difference ΔP is kept consistently throughout the operation.

Conclusively, the embodiments of the present invention shown the good effect for offsetting the Bernoulli Effect occurred in the operation of a fuel cell stack thereby improving the overall performance of the fuel cell stack.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A fuel cell, comprising:
a plurality of cell bodies electrically connected in a series manner, each of said cell bodies having an anode catalytic interface and an opposed cathode catalytic interface;
a proton exchange membrane, having a plurality of pores, sandwiched between each said two adjacent cell bodies to communicate with said anode catalytic interface and said cathode catalytic interface thereof to form a fuel cell stack; and
a reacting passage arrangement for generating an electrochemical reaction between said anode catalytic interfaces and said cathode catalytic interfaces of said cell bodies, wherein said reacting passage arrangement has a flowing channel having an inlet and an outlet for allowing a reactant to pass through said fuel cell stack from said inlet to said outlet so as to electrochemically react with said proton exchange membrane, wherein said flowing channel is shaped and sized to balance an entrance pressure of said reactant at said inlet with an exit pressure of said reactant at said outlet so as to ensure said electrochemical reaction at each two said adjacent cell bodies at a stable manner.

2. The fuel cell, as recited in claim 1, wherein said flowing channel comprises a fuel passage provided at said anode catalytic interface of each of said cell bodies for supplying a fuel as said reactant to provide electrons, an oxidant passage provided at said cathode catalytic interface of each of said cell bodies for supplying an oxidant as said reactant, wherein said fuel and said oxidant are separately guided to pass through said fuel passage and said oxidant passage respectively such that said oxidant is adapted for attracting said electrons through said proton exchange membrane so as to generate said electrochemical reaction.

3. The fuel cell, as recited in claim 2, wherein said flowing channel further comprises a coolant passage provided at said cathode catalytic interface of each of said cell bodies for supplying a coolant to pass through said fuel cell stack so as to prevent an overheat of said fuel cell stack during said electrochemical reaction.

4. The fuel cell, as recited in claim 1, wherein a depth of said flowing channel at said inlet and said outlet is at least 0.1 to 20 decimmilimeter larger than that of said flowing channel between said inlet and said outlet to balance said entrance pressure of said reactant at said inlet with said exit pressure of said reactant at said outlet.

5. The fuel cell, as recited in claim 3, wherein a depth of said flowing channel at said inlet and said outlet is at least 0.1 to 20 decimmilimeter larger than that of said flowing channel between said inlet and said outlet to balance said entrance pressure of said reactant at said inlet with said exit pressure of said reactant at said outlet.

6. The fuel cell, as recited in claim 1, wherein a width of said flowing channel at said inlet and said outlet is at least 0.1 to 20 decimmilimeter larger than that of said flowing channel between said inlet and said outlet to balance said entrance pressure of said reactant at said inlet with said exit pressure of said reactant at said outlet.

7. The fuel cell, as recited in claim 3, wherein a width of said flowing channel at said inlet and said outlet is at least 0.1 to 20 decimmilimeter larger than that of said flowing channel between said inlet and said outlet to balance said entrance pressure of said reactant at said inlet with said exit pressure of said reactant at said outlet.

8. The fuel cell, as recited in claim 1, wherein each of said cell bodies has a reacting catalyst provided at said anode catalytic interface and said cathode catalytic interface for facilitating said electrochemical reaction berebetween, wherein an amount of said reacting catalyst of said cell bodies at said inlet and said outlet is larger than an amount of said reacting catalyst of said cell bodies between said inlet and said outlet so as to ensure said electrochemical reaction at said fuel cell stack at a stable manner.

9. The fuel cell, as recited in claim 3, wherein each of said cell bodies has a reacting catalyst provided at said anode catalytic interface and said cathode catalytic interface for facilitating said electrochemical reaction berebetween, wherein an amount of said reacting catalyst of said cell bodies at said inlet and said outlet is larger than an amount of said reacting catalyst of said cell bodies between said inlet and said outlet so as to ensure said electrochemical reaction at said fuel cell stack at a stable manner.

10. The fuel cell, as recited in claim 5, wherein each of said cell bodies has a reacting catalyst provided at said anode catalytic interface and said cathode catalytic interface for facilitating said electrochemical reaction berebetween, wherein an amount of said reacting catalyst of said cell bodies at said inlet and said outlet is larger than an amount of said reacting catalyst of said cell bodies between said inlet and said outlet so as to ensure said electrochemical reaction at said fuel cell stack at a stable manner.

11. The fuel cell, as recited in claim 7, wherein each of said cell bodies has a reacting catalyst provided at said anode catalytic interface and said cathode catalytic interface for facilitating said electrochemical reaction berebetween, wherein an amount of said reacting catalyst of said cell bodies at said inlet and said outlet is larger than an amount of said reacting catalyst of said cell bodies between said inlet and said outlet so as to ensure said electrochemical reaction at said fuel cell stack at a stable manner.

12. The fuel cell, as recited in claim 3, wherein said inlet and said outlet are spacedly provided at one of said cell bodies as a first cell body positioned at one end of said fuel cell stack, such that said flowing channel is extended from said first cell body through said remaining cell bodies and back to said first cell body.

13. The fuel cell, as recited in claim 10, wherein said inlet and said outlet are spacedly provided at one of said cell bodies as a first cell body positioned at one end of said fuel cell stack, such that said flowing channel is extended from said first cell body through said remaining cell bodies and back to said first cell body.

14. The fuel cell, as recited in claim 11, wherein said inlet and said outlet are spacedly provided at one of said cell bodies as a first cell body positioned at one end of said fuel cell stack, such that said flowing channel is extended from said first cell body through said remaining cell bodies and back to said first cell body.

15. The fuel cell, as recited in claim 3, wherein said inlet is provided at one of said cell bodies as a first cell body positioned at one end of said fuel cell stack and said outlet is provide at said cell body as a last cell body positioned at another end of said fuel cell stack, such that said flowing channel is extended from said first cell body to said last cell body through said cell bodies therebetween.

16. The fuel cell, as recited in claim 10, wherein said inlet is provided at one of said cell bodies as a first cell body positioned at one end of said fuel cell stack and said outlet is provide at said cell body as a last cell body positioned at another end of said fuel cell stack, such that said flowing channel is extended from said first cell body to said last cell body through said cell bodies therebetween.

17. The fuel cell, as recited in claim 11, wherein said inlet is provided at one of said cell bodies as a first cell body positioned at one end of said fuel cell stack and said outlet is provide at said cell body as a last cell body positioned at another end of said fuel cell stack, such that said flowing channel is extended from said first cell body to said last cell body through said cell bodies therebetween.

18. The fuel cell, as recited in claim 3, wherein said inlet and said outlet are spacedly provided at one of said cell bodies positioned at a middle of said fuel cell stack, such that said flowing channel is extended from said respective cell body through two cell bodies at two ends of said fuel cell stack in coil manner and back to said respective cell body.

19. The fuel cell, as recited in claim 10, wherein said inlet and said outlet are spacedly provided at one of said cell bodies positioned at a middle of said fuel cell stack, such that said flowing channel is extended from said respective cell body through two cell bodies at two ends of said fuel cell stack in coil manner and back to said respective cell body.

20. The fuel cell, as recited in claim 11, wherein said inlet and said outlet are spacedly provided at one of said cell bodies positioned at a middle of said fuel cell stack, such that said flowing channel is extended from said respective cell body through two cell bodies at two ends of said fuel cell stack in coil manner and back to said respective cell body.
